(19) United States
(12) Patent Application Publication
(10) Pub. No.: US 2002/0004748 A1
(43) Pub. Date: Jan. 10, 2002

(54) Information providing system, information providing method, and record medium having recorded information providing program

(76) Inventors: Takahiro Koga, Tokyo (JP); Takeshi Jibiki, Tokyo (JP); Hokushi Kobayashi, Tokyo (JP)

Correspondence Address: McGuire Woods, Suite 1800, 1750 Tysons Boulevard, McLean, VA, 22102-4215, US

(21) Appl. No.: 09/899,206

(22) Filed: Jul. 6, 2001

(30) Foreign Application Priority Data
Jul. 6, 2000 (JP) 2000-205779

(51) Int. Cl. G06F 17/60

(52) U.S. Cl. 705/14

(57) ABSTRACT

A program or an advertisement that was broadcast is received, for example, by a user terminal 41 for a user A, and a corresponding “information icon” is stored in the user terminal 41. Later, when the user A selects the “information icon” which he/she would like to know in details, a “detailed my page” customized for the user A is transmitted from an information management center 3. If the user A who viewed display contents of the “detailed my page” would like to invite a user B who is one of his/her friends, he/she transmits an electronic mail with the corresponding “information icon” attached, which was addressed to a user terminal 42. Later, When the user B perused contents of the received electronic mail, and selects the “information icon” in order to know the details thereof, the “detailed my page” adjusted individually for the user B is transmitted from the information management center 3.

### BACKGROUND OF THE INVENTION

The present invention relates to an information providing system that provides viewers with, for example, information such as a program, an advertisement and so forth, an information providing method, and a record medium having recorded an information providing program.

Recently, a trend has intensified that a small amount of multi-form products are sold and the convenience of a customer is searched, and home shopping has prevailed as aging of a society advances. In this home shopping are also included online shopping and so forth using a network such as an internet and so forth. For example, the online shopping is such that a user accesses a home page of a store and the like, after viewing information of a product thereof, sends order data and purchases the product (refer to JP-A-250155/1999 and so forth).

Also, a video delivery, an auction and a data delivery that utilized a satellite system network also have been carried out.

An information providing system that used this satellite system network and the network such as the internet and so forth at the same time has been offered.

As shown in FIG. 20, this information providing system 101 comprises a broadcasting station system 102 that broadcasts via an artificial satellite S programs produced at a broadcasting station and advertisements produced by an advertising agency, and a user terminal 103 with which a user receives the program and the advertisement of the store and so forth that are broadcast with the satellite, and that can communicate with the broadcasting station system 102 via a network N such as the internet and so forth. The store as an advertising sponsor asks an advertising agent for preparation of the advertisement, and the advertising agent prepares the advertisement, transmits it to the broadcasting station system 102 and ask for broadcasting of it. The broadcasting station system 102 broadcasts the produced programs and the received advertisements via the artificial satellite S.

A user views the program and the advertisement received with the user terminal 103, and for example, if he/she is interested in the advertisement, he/she places an order to the store with a telephone, goes online shopping via the network N, or actually goes to the store for buying.

In case of purchasing a product, there is also the case in which the user purchases it by himself/herself, but sometimes, when he/she is on the mood, he/she invites a friend and goes to the store with the friend for buying the product which he/she is after, or conveys to the friend what is called word-of-mouth information to recommend it.

However, when the program and the advertisement, which were provided to the user via the broadcast and the network such as the internet and so forth, were conveyed to a third parson such as this user's friend and so forth, since only general information that does not pinpoint a target is conveyed regardless of the user information (customer information) such as an age, sex and the like of the user as a conveyer of this information and of the third parson as a recipient, the problem existed that a desire for buying was not able to be drawn sufficiently.

Also, in case that the user who received the above-mentioned information is strongly interested in this information and would like to invite a specific third person such as the friend and so forth, he/she tries to convey to the friend and so forth this information as private information with an electronic mail and so forth, but when a degree to which he/she takes interest in it is not so high, sometimes he/she feels bothered with inviting the friend and so forth, and thereby the problem existed that conveying of information to the third person or inviting was not be able to be motivated strongly.

### SUMMARY OF THE INVENTION

Accordingly, the objective of the present invention is to solve the above-mentioned tasks. Moreover, the objective of the present invention is to provide an information providing system that can sufficiently draw a desire for buying, and yet can motivate conveying of information to the third person or inviting, for example, can promote a sale of the product, an information providing method, and a record medium having recorded an information providing program.

In order to solve the tasks, an information providing system, which is a first invention, is characterized by comprising: information providing means of delivering at least anyone of first information including a pre-determined program or advertisement and second information including additional information relating to the above-mentioned first information; and an information receiving terminal for a customer that receives at least anyone of the above-mentioned first information and the above-mentioned second information, wherein in case of transmitting the above-mentioned second information to the above-mentioned information receiving terminal, the above-mentioned information providing means transmit the above-mentioned second information addressed to the above-mentioned information receiving terminal, which was prepared for the above-mentioned customer corresponding to customer information relating to the above-mentioned customer, and wherein simultaneously an information transfer path, which is used in case that the above-mentioned first information is transmitted and received between the above-mentioned information providing means and the above-mentioned information receiving terminal, and an information transfer path, which is used in case that the above-mentioned second information is transmitted and received between the above-mentioned information providing means and the above-mentioned information receiving terminal, are identical or different.

Also, an information providing system, which is a second invention, is characterized by comprising: first information providing means that deliver via a first information transfer path first information including a pre-determined program and advertisement; second information providing means that deliver via a second information transfer path second information including detailed information relating to the above-mentioned first information; and an information receiving terminal for a customer that receives the above-mentioned first information via the above-mentioned first information transfer path and that receives the above-mentioned second information via the above-mentioned second information transfer path, wherein the above-mentioned second information providing means transmit the second information addressed to the above-mentioned information receiving terminal, which was prepared for the above-mentioned customer corresponding to customer information relating to the above-mentioned customer.

Also, an information providing system, which is a third invention, is characterized by comprising: first information providing means that deliver via a first information transfer path first information including a pre-determined program and advertisement; second information providing means that deliver via a second information transfer path second information including detailed information relating to the above-mentioned first information; a first information receiving terminal for a first customer that receives the above-mentioned first information via the above-mentioned first information transfer path and that receives the above-mentioned second information via the above-mentioned second information transfer path responding to necessity; and a second information receiving terminal for a second customer that receives at least the above-mentioned second information responding to necessity, wherein the above-mentioned first information receiving terminal transmits to the above-mentioned second information receiving terminal for the above-mentioned second customer via the above-mentioned second information providing means recommendation information for at least one above-mentioned second customer, which was prepared based on either the above-mentioned first or second information, and wherein the above-mentioned second information providing means transmit to the above-mentioned information receiving terminal the above-mentioned second information for the above-mentioned first customer, which was prepared corresponding to first customer information relating to the above-mentioned first customer, responding to a request from the above-mentioned first information receiving terminal, and in case that it received the above-mentioned recommendation information from the above-mentioned first information receiving terminal, it simultaneously transfers the above-mentioned recommendation information to the above-mentioned second information receiving terminal and yet transmits to the above-mentioned second information receiving terminal the above-mentioned second information for the above-mentioned second customer, which was prepared corresponding to the above-mentioned recommendation information and second customer information relating to the above-mentioned second customer, responding to a request from the above-mentioned second information receiving terminal.

Also, an information providing system, which is a fourth invention, is characterized in that the above-mentioned first information receiving terminal prepares recommendation information for a single or plural specific above-mentioned second customer(s) based on the above-mentioned first or the above-mentioned second information responding to necessity to transmit the above-mentioned recommendation information to the above-mentioned second information receiving terminal via the above-mentioned second information providing means.

Also, an information providing system, which is a fifth invention, is characterized by comprising evaluation means of making an evaluation for rewarding the above-mentioned first customer responding to a contribution degree by the above-mentioned first customer to prevalence of at least the above-mentioned first information.

Also, an information providing system, which is a sixth invention, is characterized in that, in case that the above-mentioned first information includes advertising information, the above-mentioned evaluation means make an evaluation for rewarding the above-mentioned first customer responding to a contribution degree to commercial transaction achievements relating to products or services as an object of an advertisement.

Also, an information providing system, which is a seventh invention, is characterized by comprising: information management means of managing communication information indicating that at least the above-mentioned first information was prevailed by the above-mentioned first or second customer; and information analysis means of executing a collection and analysis process for the above-mentioned communication information to obtain an analysis result on a prevalence situation of the above-mentioned first information, which is to be offered to a provider of the above-mentioned first information.

Also, an information providing system, which is an eighth invention, is characterized in that the above-mentioned information analysis means execute a collection and analysis process for the above-mentioned communication information based on customer information of the above-mentioned first and second customers who transmit and receive at least the above-mentioned first information. Also, an information providing system, which is a ninth invention, is characterized by comprising a third information receiving terminal for the above-mentioned second customer that receives at least prompt report information that corresponds to the above-mentioned recommendation information, wherein the above-mentioned second information providing means transmit the above-mentioned prompt report information to the above-mentioned third information receiving terminal responding to a request by the above-mentioned first information receiving terminal.

Also, an information providing system, which is a tenth invention, is characterized in that the above-mentioned second information providing means transmit to the above-mentioned second information receiving terminal at least prompt report information, which corresponds to the above-mentioned recommendation information, responding to a request by the above-mentioned first information receiving terminal.

Also, an information providing system, which is an eleventh invention, is characterized in that, after the above-mentioned second information providing means transmitted to the above-mentioned second information receiving terminal the above-mentioned recommendation information received from the above-mentioned first information receiving terminal, it transmits the above-mentioned prompt report information to the above-mentioned third information receiving terminal in case that no reply from the above-mentioned second information receiving terminal is present within a pre-determined time.

Also, an information providing system, which is a twelfth invention, characterized in that the above-mentioned customer information includes at least anyone of a name, a race, a nationality, sex, an address, an age, and an occupation.

Also, an information providing method, which is a thirteenth invention, is characterized by comprising: an information providing step of delivering at least anyone of first information including a pre-determined program or advertisement and second information including additional information relating to the above-mentioned first information; and an information receiving step of receiving at least anyone of the above-mentioned first information and the above-mentioned second information with an information receiving terminal for a customer, wherein, in the above-mentioned information providing step, in case of transmitting the above-mentioned second information to the above-mentioned information receiving terminal with the above-mentioned information providing means, the above-mentioned second information addressed to the above-mentioned information receiving terminal, which was prepared for the above-mentioned customer corresponding to customer information relating to the above-mentioned customer, is transmitted, and wherein simultaneously an information transfer path, which is used in case that the above-mentioned first information is transmitted and received between the above-mentioned information providing means and the above-mentioned information receiving terminal, and an information transfer path, which is used in case that the above-mentioned second information is transmitted and received between the above-mentioned information providing means and the above-mentioned information receiving terminal, are identical or different. Also, an information providing method, which is a fourteenth invention, is characterized by comprising: a first information providing step of delivering first information including a pre-determined program or advertisement via a first information transfer path with first information providing means; a second information providing step of delivering second information including detailed information relating to the above-mentioned first information via a second information transfer path with second information providing means; and an information receiving step of receiving the above-mentioned first information via the above-mentioned first transfer path and of receiving the above-mentioned second information via the above-mentioned second information transfer path with an information receiving terminal for a customer, wherein, in the above-mentioned second information providing step, with the above-mentioned information providing means, second information addressed to the above-mentioned information receiving terminal, which was prepared for the above-mentioned customer corresponding to customer information relating to the above-mentioned customer, is transmitted.

Also, an information providing method, which is a fifteenth invention, is characterized by comprising: a first information providing step of delivering first information including a pre-determined program or advertisement via a first information transfer path with first information providing means; a second information providing step of delivering second information including detailed information relating to the above-mentioned first information via a second information transfer path with second information providing means; a first information receiving step of receiving the above-mentioned first information via the above-mentioned first transfer path and of receiving the above-mentioned second information via the above-mentioned second information transfer path responding to necessity with a first information receiving terminal for a customer; and a second information receiving step for a second customer of receiving at least the above-mentioned second information responding to necessity via the above-mentioned second information transfer path with a second information receiving terminal for a second customer, wherein, with the above-mentioned first information receiving terminal, recommendation information for at least one above-mentioned second customer, which was prepared based on the above-mentioned first or the above-mentioned second information, is transmitted to the above-mentioned second information receiving terminal for the above-mentioned second customer via the above-mentioned second information providing means responding to necessity, and wherein the above-mentioned second information providing means transmit to the above-mentioned first information receiving terminal the above-mentioned second information for the above-mentioned first customer, which was prepared corresponding to first customer information relating to the above-mentioned first customer, responding to a request from the above-mentioned first information receiving terminal, simultaneously, in case that it received the above-mentioned recommendation information from the above-mentioned first information receiving terminal, it transmits the above-mentioned recommendation information to the above-mentioned second information receiving terminal, and yet transmits to the above-mentioned second information receiving terminal the above-mentioned second information for the above-mentioned second customer, which was prepared corresponding to the above-mentioned recommendation information and second customer information relating to the above-mentioned second customer, responding to a request from the above-mentioned second information receiving terminal.

Also, an information providing method, which is a sixteenth invention, is characterized by comprising an evaluation step of making an evaluation for rewarding the above-mentioned first customer responding to a contribution degree by the above-mentioned first customer to prevalence of at least the above-mentioned first information.

Also, an information providing method, which is a seventeenth invention, is characterized in that, in case that the above-mentioned first information includes advertising information, an evaluation is made for rewarding the above-mentioned first customer responding to a contribution degree to commercial transaction achievements relating to products or services as an object of an advertisement.

Also, an information providing method, which is an eighteenth invention, is characterized by comprising: information management means of managing communication information indicating that at least the above-mentioned first information was prevailed by the above-mentioned first or second customer; and information analysis means of executing a collection and analysis process for the above-mentioned communication information to obtain an analysis result on a prevalence situation of the above-mentioned first information, which is to be offered to a provider of the above-mentioned first information.

Also, an information providing method, which is a nineteenth invention, is characterized by comprising: a prompt report information transmission step of transmitting to a third information receiving terminal for the above-mentioned second customer at least prompt report information, which corresponds to the above-mentioned recommendation information, responding to a request by the above-mentioned first information receiving terminal with the above-mentioned second information providing means; and a prompt report information receiving step of receiving the above-mentioned prompt report information with the above-mentioned third information reception terminal, wherein, in the above-mentioned prompt report transmission step, with the above-mentioned third information means, after the above-mentioned recommendation information received from the above-mentioned first information receiving terminal was transmitted to the above-mentioned second information receiving terminal, the above-mentioned prompt report information is transmitted to the above-mentioned third information receiving terminal in case that no reply from the above-mentioned second information reception terminal is present within a pre-determined time.

Also, a record medium having recorded an information providing program, which is a twentieth invention, is characterized in that a program is recorded for causing a computer to execute: an information providing step of delivering at least anyone of first information including a pre-determined program or advertisement and second information including additional information relating to the above-mentioned first information with information providing means; and an information receiving step of receiving at least anyone of the above-mentioned first information and the above-mentioned second information with an information reception terminal for a customer, wherein, in the above-mentioned information providing step, in case of transmitting the above-mentioned second information to the above-mentioned information receiving terminal with the above-mentioned information providing means, the above-mentioned second information addressed to the above-mentioned information receiving terminal, which was prepared for the above-mentioned customer corresponding to customer information relating to the above-mentioned customer, is transmitted, and wherein simultaneously an information transfer path, which is used in case that the above-mentioned first information is transmitted and received between the above-mentioned information providing means and the above-mentioned information receiving terminal, and an information transfer path, which is used in case that the above-mentioned second information is transmitted and received between the above-mentioned information providing means and the above-mentioned information receiving terminal, are identical or different.

Also, a record medium having recorded an information providing program, which is a twenty-first invention, is characterized in that a program is recorded for causing a computer to execute a first information providing step of delivering first information including a pre-determined program or advertisement via a first information transfer path with first information providing means, a second information providing step of delivering second information including detailed information relating to the above-mentioned first information via a second information transfer path with second information providing means, and an information receiving step of receiving the above-mentioned first information via the above-mentioned first information transfer path and of receiving the above-mentioned second information via the above-mentioned second information transfer path with an information receiving terminal for a customer, wherein, in the above-mentioned second information providing step, with the above-mentioned second information providing means, second information addressed to the above-mentioned information receiving terminal, which was prepared for the above-mentioned customer corresponding to customer information relating to the above-mentioned customer, is transmitted.

Also, a record medium having recorded an information providing program, which is a twenty-second invention, is characterized in that a program is recorded for causing a computer to execute: a first information providing step of delivering first information including a pre-determined program or advertisement via a first information transfer path with first information providing means; a second information providing step of delivering second information including detailed information relating to the above-mentioned first information via a second information transfer path with second information providing means; a first information receiving step of receiving the above-mentioned first information via the above-mentioned first information transfer path with a first information receiving terminal for a first customer and of receiving the above-mentioned second information via the above-mentioned second information transfer path responding to necessity with an information receiving terminal for a customer; and a second information receiving step for a second customer of receiving at least the above-mentioned second information via the above-mentioned second information transfer path responding to necessity with a second information receiving terminal for a second customer, wherein recommendation information for at least one above-mentioned second customer, which was prepared based on the above-mentioned first or the above-mentioned second information, is transmitted to the above-mentioned second information receiving terminal for the above-mentioned second customer via the above-mentioned second information providing means, responding to necessity with the above-mentioned first information receiving terminal, and wherein the above-mentioned second information providing means transmit to the above-mentioned first information receiving terminal the above-mentioned second information for the above-mentioned first customer, which was prepared corresponding to first customer information relating to the above-mentioned first customer, responding to a request from the above-mentioned first information receiving terminal, simultaneously, in case that it received the above-mentioned recommendation information from the above-mentioned first information receiving terminal, it transfers the above-mentioned recommendation information to the above-mentioned second information receiving terminal, and yet transmits to the above-mentioned second information receiving terminal the above-mentioned second information for the above-mentioned second customer, which was prepared corresponding to the above-mentioned recommendation information and second customer information relating to the above-mentioned second customer, responding to a request from the above-mentioned second information receiving terminal.

Also, a record medium having recorded an information providing program, which is a twenty-third invention, is characterized in that a program was recorded for causing a computer to execute an evaluation step of making an evaluation for rewarding the above-mentioned first customer responding to a contribution degree by the above-mentioned first customer to prevalence of at least the above-mentioned first information.

Also, a record medium having recorded an information providing program, which is a twenty-forth invention, is characterized in that, in the above-mentioned evaluation step, in case that the above-mentioned first information includes advertising information, an evaluation is made for rewarding the above-mentioned customer responding to a contribution degree to commercial transaction achievements relating to products or services as an object of an advertisement.

Also, a record medium having recorded an information providing program, which is a twenty-fifth invention, is characterized in that a program is recorded for causing a computer to execute: a prompt report information transmission step of transmitting at least prompt report information, which corresponds to the above-mentioned recommendation information to a third information receiving terminal for the above-mentioned second customer, responding to a request by the above-mentioned first information receiving terminal with the above-mentioned second information providing means; and a prompt report information receiving step of receiving the above-mentioned prompt report information with the above-mentioned third information receiving terminal, and wherein, in the above-mentioned prompt report information transmission step, with the above-mentioned second information providing means, after the above-mentioned recommendation information received from the above-mentioned first information receiving terminal was transmitted to the above-mentioned second information receiving terminal, the above-mentioned prompt report information is transmitted to the above-mentioned third information receiving terminal in case that no reply from the above-mentioned second information receiving terminal is present within a pre-determined time.

### BRIEF DESCRIPTION OF THE DRAWING

This and other objects, features and advantages of the present invention will become more apparent upon a reading of the following detailed description and drawings, in which:

FIG. 1 is a diagram illustrating an arrangement of an information providing system that is a first example of the present invention;

FIG. 2 is a block diagram illustrating an arrangement of a broadcasting station system in the same information providing system;

FIG. 3 is a block diagram illustrating an arrangement of an information management center in the same information providing system;

FIG. 4 is a block diagram illustrating an arrangement of a management server and a delivery information storage server in the same broadcasting station system and in the same information management center;

FIG. 5 is a block diagram illustrating an arrangement of a user terminal in the same information providing system;

FIG. 6 is an explanation diagram for explaining an operation of the same information providing system;

FIG. 7 is a flowchart for explaining an operation of the same management server in the same information management center;

FIG. 8 is a flowchart for explaining an operation of the same user terminal;

FIG. 9 is a flowchart for explaining an operation of the same user terminal;

FIG. 10 is a flowchart for explaining an operation of the same user terminal;

FIG. 11 is a flowchart for explaining an operation of the same management server in the same information management center;

FIG. 12 is a flowchart for explaining an operation of the same management server in the same information management center;

FIG. 13 is a flowchart for explaining an operation of the same delivery information storage server in the same information management center;

FIG. 14 is a diagram illustrating an example of a display image being displayed on an indicator of the same user terminal;

FIG. 15 is a diagram illustrating an example of a display image being displayed on an indicator of the same user terminal;

FIG. 16 is diagram illustrating an example of a display image being displayed on an indicator of the same user terminal;

FIG. 17 is diagram illustrating an example of a display image being displayed on an indicator of the same user terminal;

FIG. 18 is a diagram illustrating an arrangement of an information providing system that is a second example of the present invention;

FIG. 19 is a block diagram illustrating an arrangement of an ISP system in the same information providing system; and

FIG. 20 is an explanation diagram for explaining a prior art.

### DESCRIPTION OF THE EMBODIMENTS

Hereinafter, embodiments of the present invention will be explained in details, referring to the accompanied drawings. An explanation will be done specifically by use of examples.

A first example

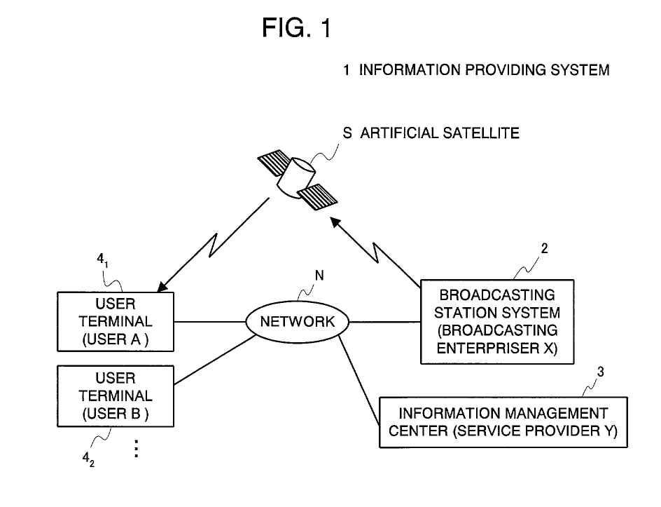

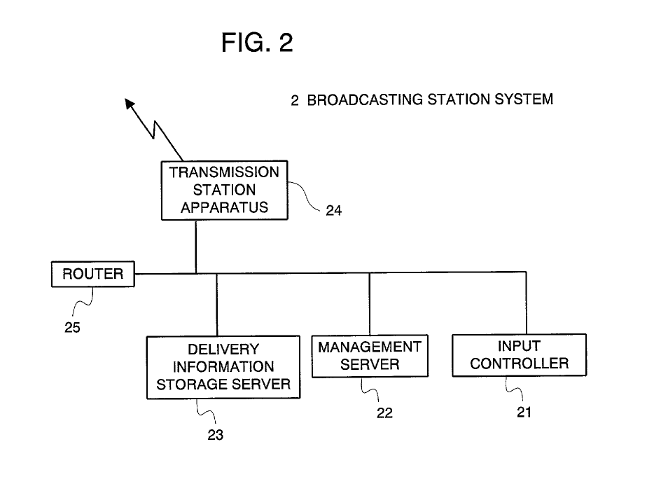

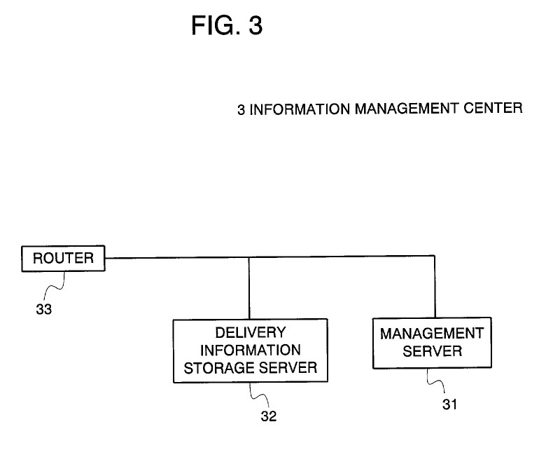

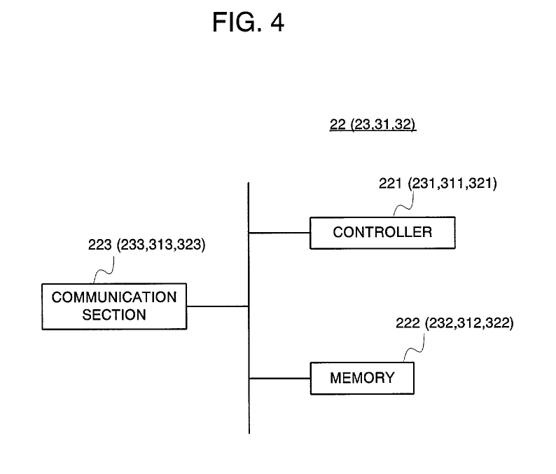

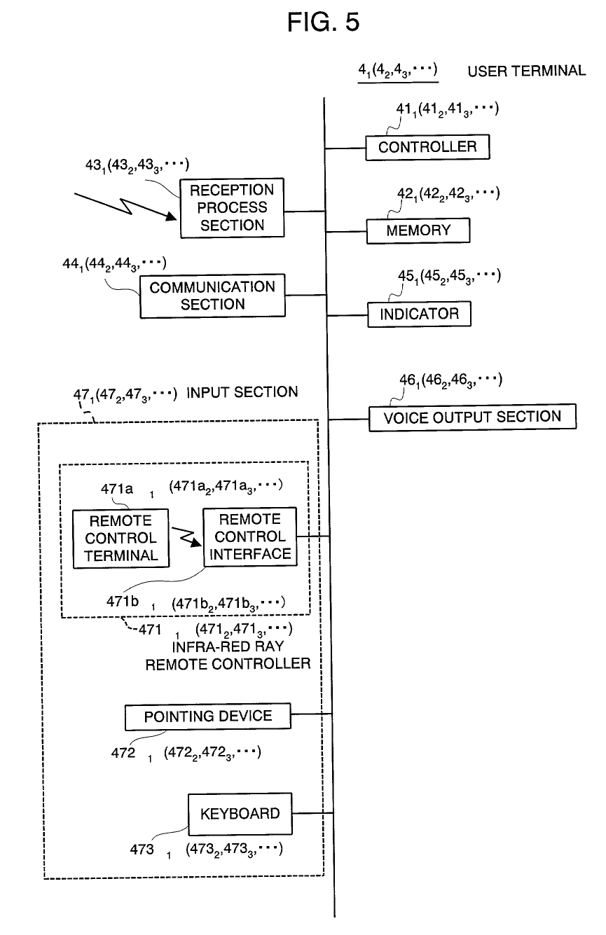

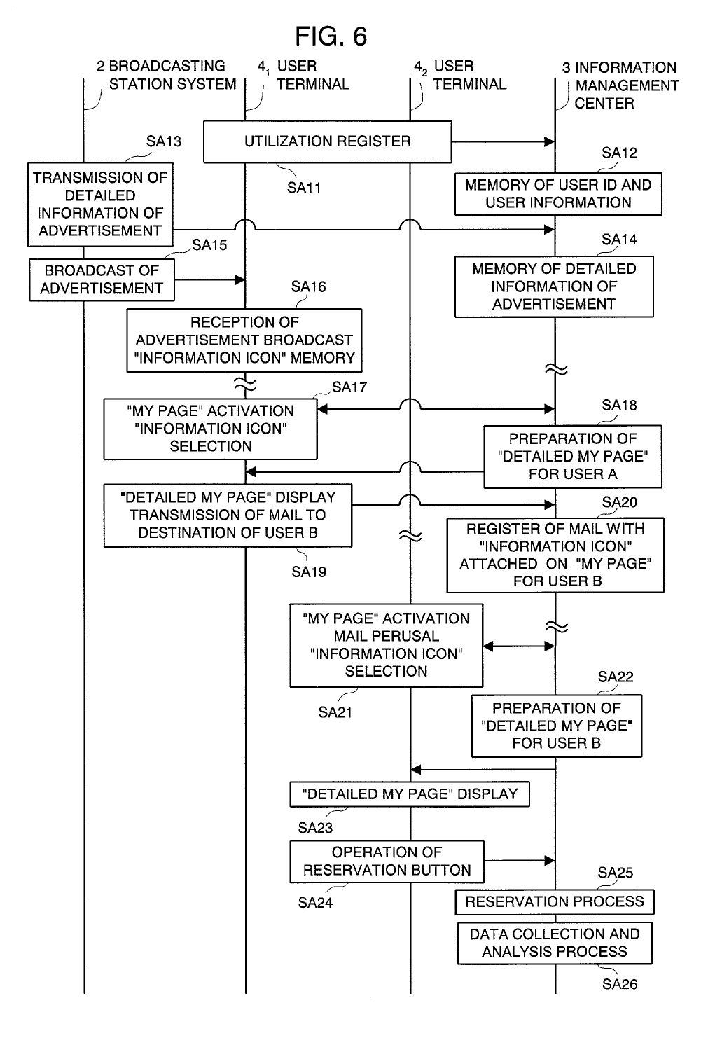

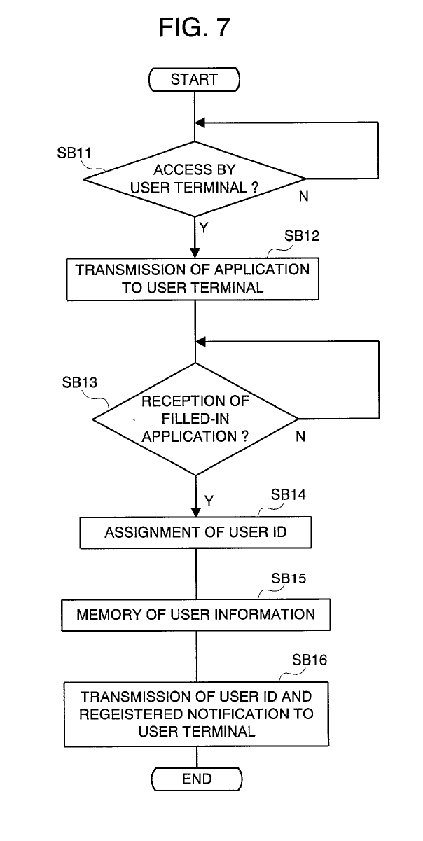

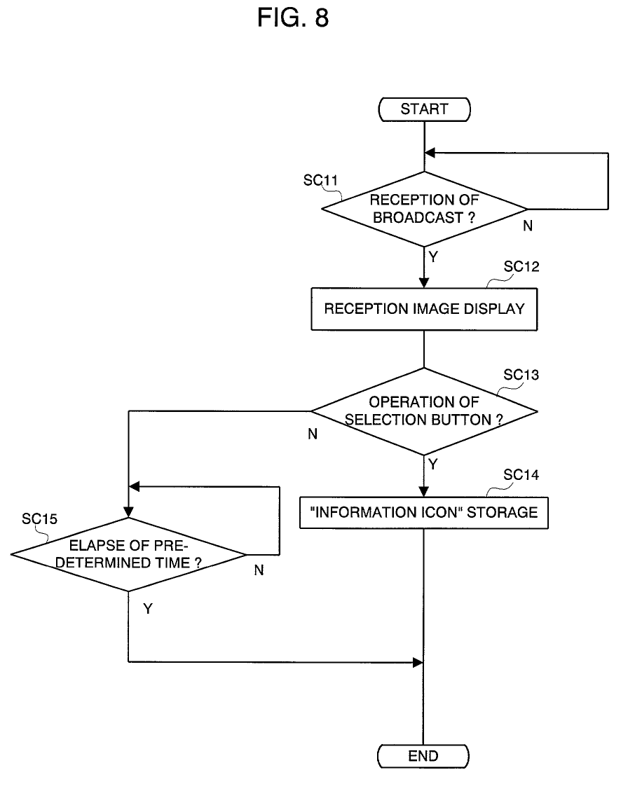

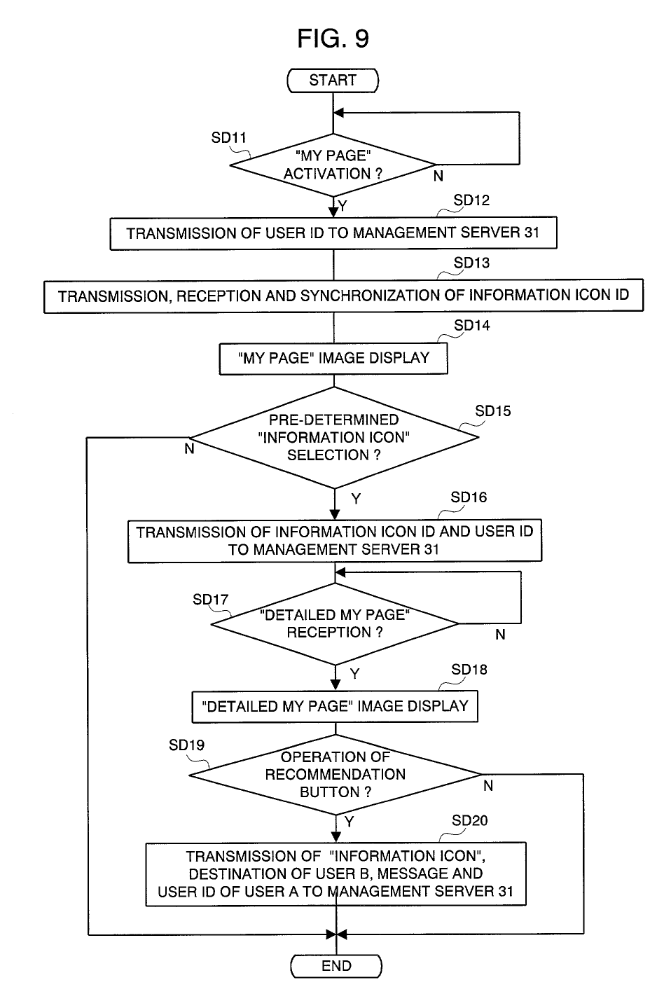

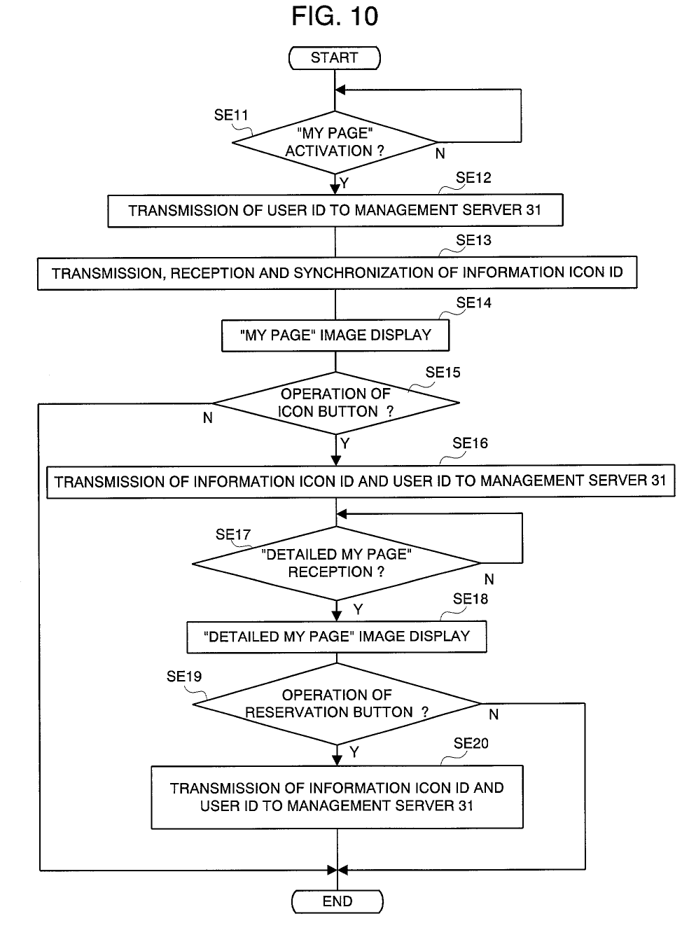

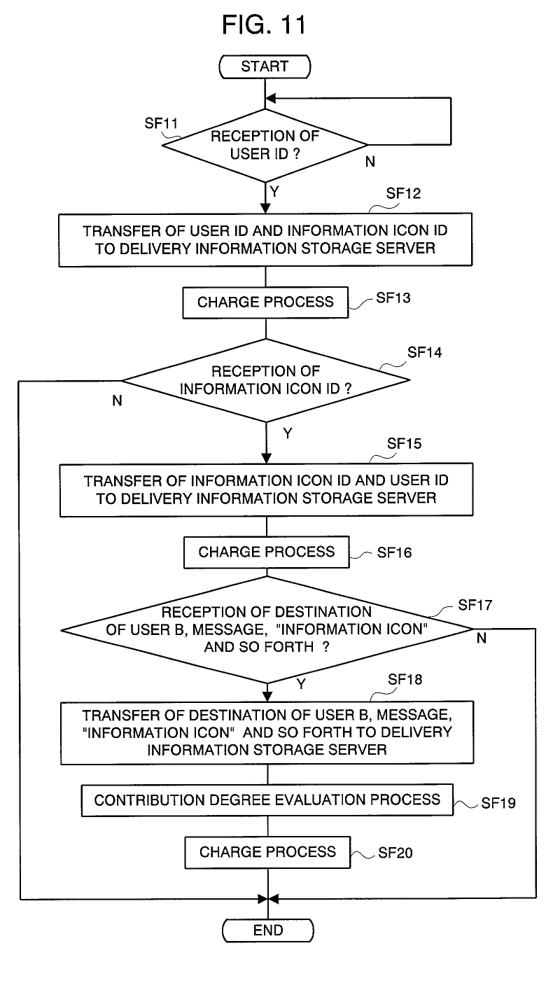

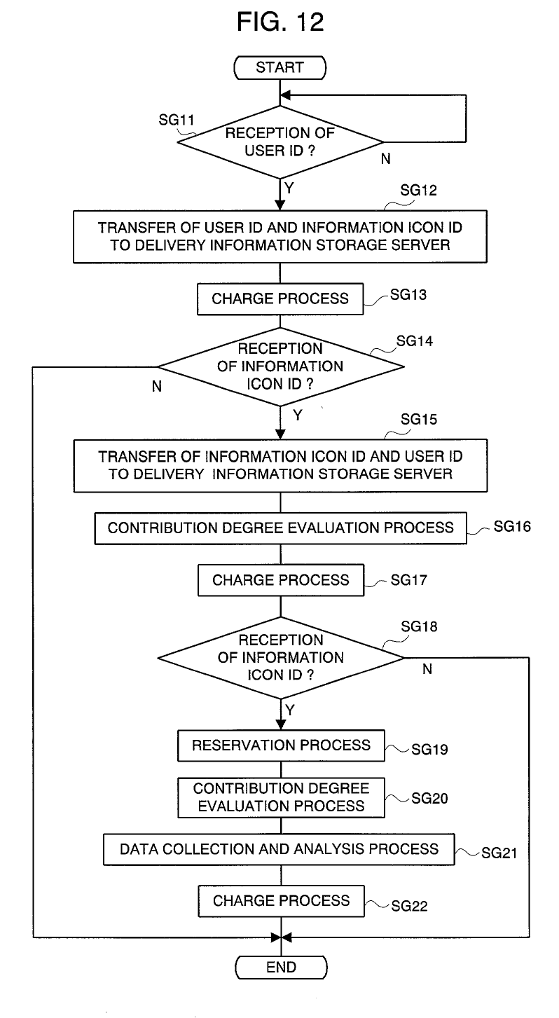

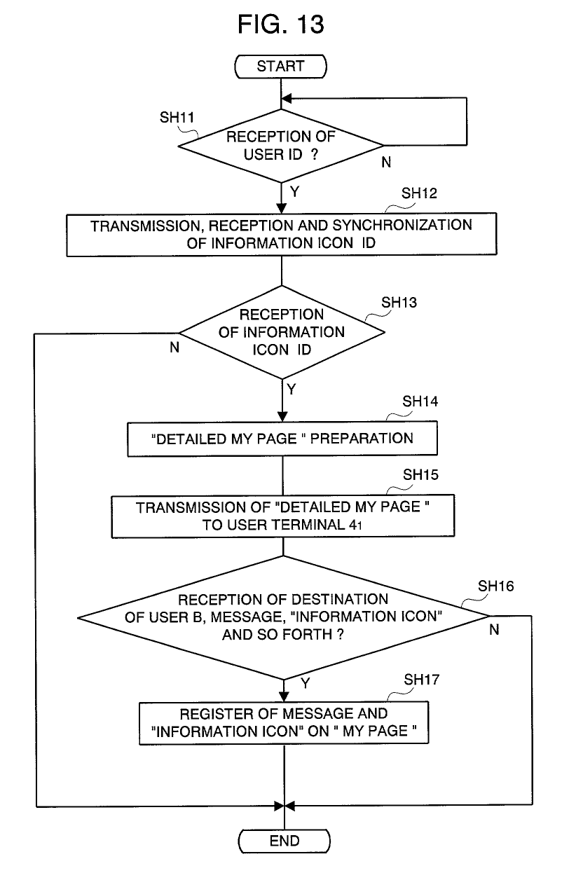

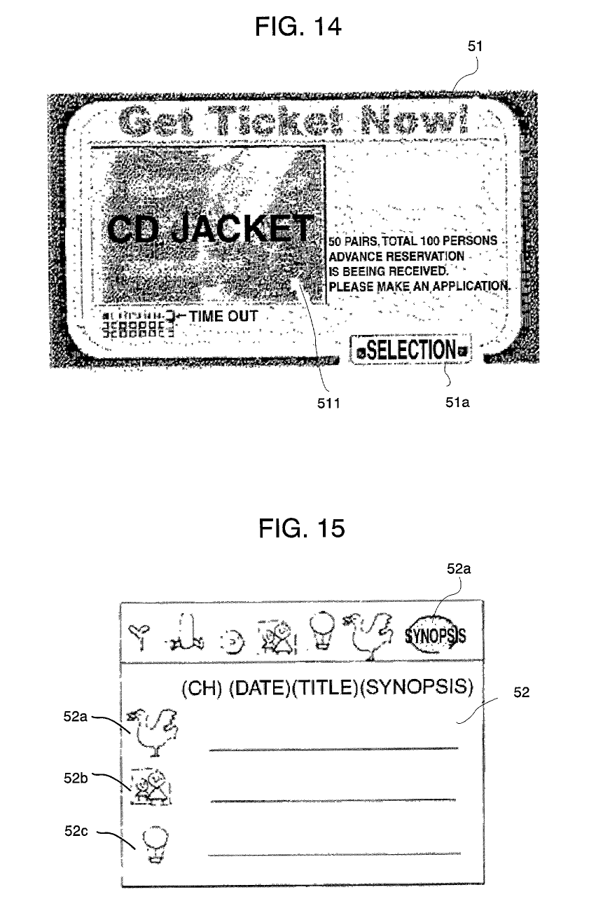

FIG. 1 is a diagram illustrating an arrangement of an information providing system that is a first example of the present invention, FIG. 2 is a block diagram illustrating an arrangement of a broadcasting station system in the same information providing system, FIG. 3 is a block diagram illustrating an arrangement of an information management center in the same information providing system, FIG. 4 is a block diagram illustrating an arrangement of a management server and a delivery information storage server in the same broadcasting station system and in the same information management center, FIG. 5 is a block diagram illustrating an arrangement of a user terminal in the same information providing system, FIG. 6 is an explanation diagram for explaining an operation of the same information providing system, FIG. 7 is a flowchart for explaining an operation of the same management server in the same information management center, FIG. 8 to FIG. 10 are flowcharts for explaining an operation of the same user terminal, FIG. 11 and FIG. 12 are flowcharts for explaining an operation of the same management server in the same information management center, FIG. 13 is a flowchart for explaining an operation of the same delivery information storage server in the same information management center, and FIG. 14 to FIG. 17 are diagrams illustrating examples of display images being displayed on an indicator of the same user terminal.

As shown in FIG. 1, an information providing system 1 of this example comprises a broadcasting station system (first information providing means) 2 that, for example, broadcasts a produced advertisement by use of an artificial satellite S and simultaneously transmits detailed information relating to the above-mentioned advertisement via a network (a second information transfer path) N such as an internet and so forth, an information management center 3 (second information providing means) that a service provider Y manages, which receives detailed information relating to the advertisement from the broadcasting station system 2 via the network N to register it, and a number of user terminals (information receiving terminals, a first information receiving terminal and a second receiving terminal) 41, 42 that receive the advertisement, which is broadcast with the satellite, and simultaneously receive detailed information relating to the above-mentioned advertisement from the information management center 3 via the network N.

The broadcasting station system 2 includes an input controller 21 that controls input of, for example, two kinds of contents, i.e. one for satellite data broadcasting and the other for network delivering, which is delivered via the network N, relating to the advertisement, a management server 22 that manages the entirety of the broadcasting station system 2 and also manages, for example, information relating to an advertising sponsor, an advertising agent and so forth, a delivery information storage server 23 that stores information relating to the advertisement that was input, transmits information for satellite broadcasting to a transmission station apparatus 24, which will be described later, according to a broadcasting schedule and transmits information for network delivering to the information management center 3 responding to necessity; the transmission station apparatus 24 for transmitting the advertisement for satellite broadcasting; and a router 25.

The broadcasting station gets from the advertising agent, for example, two kinds of advertisements with regard to the identical advertising object, which are the advertisement for satellite data broadcasting and the advertisement with much smaller detail for delivering via the above-mentioned network, and information of these advertisements is input as image data, voice data, text data and so forth via the input controller 21. Herein, the information relating to the advertisement for delivering via the above-mentioned network includes the detailed contents relating to the advertisement for the satellite data broadcasting, and simultaneously is prepared in a generalized form (for example, expressed in variables) so that a pre-determined area can be changed in order to adjust (to customize) individually for each user later.

As shown in FIG. 4, the management server 22 includes a controller 221 that controls each component according to a pre-determined control program, a memory 222 in which various kinds of programs and data are stored, and a communication section 223 for making a data communication according to a pre-determined protocol.

The controller 221 executes various kinds of process programs stored in the memory 222, utilizes various kinds of registers and flags kept in the memory 222 to control each component of the management server 22, and executes a transmission command of information relating to the advertisement to the delivery information storage server 23, a user (an advertising sponsor and the like) information management process, a communication process and so forth.

The memory 222 comprises a semiconductor memory such as a ROM, a RAM, an IC memory card and so forth, a floppy disk memory device, a hard disk memory device, a magneto-optical disk memory device, and the like, wherein various kinds of registers and flags are kept which are used when the controller 221 executes the programs.

The delivery information storage server 23, which is the same as the management server 22 in terms of a general arrangement of a hardware, includes a controller 231 that controls each component according to a pre-determined control program, a memory 232 in which various kinds of programs and data are stored, and a communication section 233 for making a data communication according to a pre-determined protocol as shown in FIG. 4.

In the memory 232 are stored information relating to the advertisement for satellite broadcasting, and detailed information relating to the advertisement for network delivering, which is delivered via the network N.

The above-mentioned information for satellite broadcasting and the above-mentioned information for network delivering both include a program group (hereinafter, referred to as an “information icon”) that carries out image display and voice output, which corresponded to, for example, contents of the advertisement, according to respective pre-determined process procedures, by an icon button being operated by a user, which was indicated as picture characters displayed on the display image by use of, for example, a pointing device such as a mouse and the like.

For example, the “information icon” for the advertisement includes a sales promotion menu program such as information relating to products and services that the advertising sponsor sells, coupon information (including privilege information such as a gift, a discount and so forth) and so forth. By this “information icon”, for example, the image display relating to product information of a CD for music is carried out and the voice output including contents of the above-mentioned CD for music is carried out for offering the product information.

Also, after this “information icon” was received, and once the contents thereof were sighted and heard by a user, they can be attached to an electronic mail and can be transmitted to a plurality of third persons, the viewed contents are transferred to a relatively small specific persons as “private information”, and information relating to the pre-determined advertisement that corresponds to the “information icon” results in being prevailed widely and surely.

As shown in FIG. 3, the information management center 3 includes a management server (evaluation means, information management means and information analysis means) 31 that manages the entirety of the information management center 3, simultaneously receives detailed information relating to the advertisement from the broadcasting system 2 via the network N, manages user information obtained at the time of a utilization register, manages utilization status by a user of this information providing system 1, and further asks the advertising sponsor's share of a utilization charge of the information providing system 1, for example, based on utilization status by the user of this system, a delivery information storage server 32 that stores received information for network delivering relating to the advertisement, and executes a customization process for the above-mentioned information for network delivering for each user to transmit it to user terminals 41, 42, . . . ; and a router 33.

As shown in FIG. 4, the management server 31, which is the same as the management server 22 in terms of a general arrangement of a hardware, includes a controller 311 that controls each component according to a pre-determined control program; a memory 312 in which various kinds of programs and data are stored, and a communication section 313 for making a data communication according to a pre-determined protocol.

The controller 311 executes various kinds of process programs stored in the memory 312, utilizes various kinds of registers and flags kept in the memory 312 to control each component of the management server 31, executes a user information management process, a transmission command to the delivery information storage server 32 that detailed information relating to the advertisement be transmitted to user terminals 41, 42, . . . , a charge process to ask the advertising sponsor's share of the utilization charge of the information providing system 1, for example, based on utilization status by the user of this system, a collection and analysis process of the utilization status of this system by the user, an evaluation process of a contribution degree by a user, and so forth.

The memory 312 comprises a semiconductor memory such as a ROM, a RAM, an IC memory card and so forth, a floppy disk memory device, a hard disk memory device, a magneto-optical disk memory device, and the like, wherein various kinds of process programs are stored such as an information management process program, a charge process program, a data collection and an analysis process program, a contribution degree evaluation process program and so forth, and simultaneously various kinds of registers and flags are kept which are used when the controller 311 executes the programs.

The delivery information storage server 32, which is the same as the delivery information storage server 23 in terms of a general arrangement of a hardware, includes a controller 321 that controls each component according to a pre-determined control program, a memory 322 in which various kinds of programs and data are stored, and a communication section 323 for making a data communication according to a pre-determined protocol as shown in the same Figure.

In the memory 322 are stored detailed information relating to the advertisement for network delivering, a program (hereinafter, referred to as a “my page”) that is prepared for each user and used for operating the above-mentioned “information icon”, a customization process program for receiving user information from the management server 31 to customize the above-mentioned detailed information based on this user information, a program (hereinafter, referred to as a “detailed my page”) including detailed information customized for each user, and so forth.

As shown in FIG. 5, the user terminal 41 includes a controller 411 that a user (a customer, a first customer and a second customer) A uses, which controls each component according to a pre-determined control program, a memory 421 in which various kinds of programs and data are stored; a reception process section 431 for receiving, for example, satellite broadcasting data, which comprises an antenna, a tuner and so forth, a communication section 441 for making a data communication with the information management center 3 and so forth according to a pre-determined protocol via the network N, an indicator 451 that displays on the display screen information and so forth relating to the advertisement, a voice output section 461 that outputs as voice information and so forth relating to the advertisement, an input section 471 for carrying out a data input operation and so forth. The controller 411 executes process programs stored in a program memory 4211 of the memory 421, which will be described later, controls each component of the user terminal 41 using various kinds of registers and flags kept in the memory 421, and makes a communication process and so forth.

The memory 421 comprises a semiconductor memory such as a ROM, a RAM, an IC memory card and so forth, a floppy disk memory device, a hard disk memory device, a magneto-optical disk memory device and the like, wherein are stored various kinds of process programs that the controller 411 executes, various kinds of information such as information relating to the advertisement including the received “information icon”, the “my page” that is almost the same as one stored for each user in the memory 322, and so forth, and simultaneously are kept various kinds of registers and flags which are used when the controller 411 executes the programs. In addition, in this example, the “my page” has been pre-installed.

The indicator 451 comprises a CRT display, a liquid crystal display, a plasma display, or the like.

The input section 471 includes an infrared-ray remote controller 4711, a pointing device 4721 such as a mouse and so forth, a keyboard 4731 for entering a key stroke.

The infrared-ray remote controller 4711 comprises a remote control terminal 471a1 that generates a infrared-ray signal responding to an operational key, and a remote control interface 471b1 that receives the infrared-ray signal from the remote control terminal 471a1 and sends a signal to the controller 411 responding to the received infrared-ray signal.

In addition, the user terminal 42 (43, 44, . . . ) for a user B (C, D, . . . ), of which arrangement is the same as that of the user terminal 41, includes a controller 412 (413, 414, . . . ), a memory 422 (423, 424, . . . ), a reception process section 432 (433, 434, . . . ), a communication section 442 (443, 444, . . . ), an indicator 452 (453, 454, . . . ), a voice output section 462 (463, 464, . . . ), and an input section 472 (473, 474, . . . ).

Also, the input section 472 (473, 474, . . . ) includes an infra-red ray remote controller 4712 (4713, 4714, . . . ), a pointing device 4722 (4723, 4724, . . . ) and a keyboard 4732 (4733, 4734, . . . ).

Also, the infrared-ray remote controller 4712 (4713, 4714, . . . ) comprises a remote control terminal 471a2 (471a3, 471a4, . . . ) and a remote control interface 471b2 (471b3, 471b4, . . . ).

Next, an information providing method that utilized this information providing system 1 will be explained, referring to FIG. 6 to FIG. 17.

At first, an outline of the information providing method of this example will be explained.

Firstly, each user A (B, C, . . . ) makes a utilization register for a membership to the information management center 3 with the user terminal 41 (42, 43, . . . )(step SA11 (FIG. 6)). In FIG. 6, as an example, the case is shown in which the users A and B make the utilization register with the user terminals 41 and 42.

In addition, in this example, it is not essential to become a membership. However, services that can be enjoyed are limited.

Thereby, in the information management center 3 are stored a user ID of each user A (B, C, . . . ) and user information (step SA12).

The advertisement that the advertising agent prepared and the detailed information thereof, which respond to information for satellite broadcasting, are transmitted from the delivery information storage server 23 of the broadcasting station system 2 to the information management center 3 (step SA13), and are stored in the delivery information storage server 32 of the information management center 3 (step SA14).

In addition, the advertisement and the detailed information thereof are what the advertising agenct prepared to send to the broadcasting station at the advertising sponsor's request.

Next, a pre-determined advertisement is read out from the delivery information storage server 23 of the broadcasting station system 2, transmitted from the transmission station apparatus 24, and delivered for broadcasting (step SA15).

In case that, for example, the user terminal 41 for the user A receives the broadcast advertisement, which is displayed on the display screen, upon selecting this advertisement responding to the user A's taste, the corresponding “information icon” is stored in the user terminal 41 (step SA16).

Later, when the user A activates the “my page” responding to his/her taste or responding to necessity, and selects the required “information icon”, which he/she would like to know in details (step SA17), an information icon ID is transmitted to the information management center 3 together with the user ID of the user A.

In the information management center 3, the “detailed my page” customized for the user A is prepared (step SA18) and transmitted to the user terminal 41.

In the user terminal 41, the “detailed my page” is displayed on the display screen, and if the user A who viewed display contents would like to invite a friend, for example, the user B, he/she transmits an electronic mail with the corresponding “information icon” attached, which was addressed to the user terminal 41 for the user B (step SA19).

When, in the information management center 3, the electronic mail with the “information icon” attached is received, this “information icon” and contents of the electronic mail is registered on the “my page” for the user B (step SA20).

Later, when the user B activates the “my page” responding to his/her taste or responding to necessity, peruses contents of the incoming electronic mail, and selects the “information icon” in order to know the details thereof (step SA21), the information icon ID is transmitted together with the ID of the user B to the information management center 3.

In the information management center 3, the “detailed my page” customized for the user B (step SA22) is prepared and transmitted to the user terminal 42.

In the user terminal 42, the “detailed my page” is displayed on the display screen (step SA23), and if the user B who viewed the display contents would like to reserve for buying a product, he/she operates a reservation button (step SA24) to transmit to the information management center 3 the corresponding information icon ID and the user ID of the user B.

In the information management center 3, after receiving the information icon ID and the user ID, a reservation process is executed (step SA25), and the data collection and analysis process is executed based on the result transmitted and received between each of the user terminals 41 (42, 43, . . . ) and the information management center 3 (step SA26).

Also, the information management center 3 manages each of data obtained by transmitting/receiving to/from each of the user terminals 41 (42, 43, . . . ), and, for example, based on the fact that the user A transferred the reception contents to the user B, on the fact that the user B perused the electronic mail transmitted from the user A, and on the contents of the electronic mail and the detailed information transmitted from the user A, it evaluates a contribution degree by the user A respectively on the fact that the user B reserved for products or services to add an evaluation score responding to a contribution degree. A reward (a discount service, a privilege service, and so forth) is given to the user A responding to a total of evaluation scores at this time.

Next, a method of the utilization register will be described in details.

At first, for example, the user A accesses the management server 31 of the information management center 3 via the network N with the user terminal 41.

In the management server 31, when the access by the user terminal 41 is present (step SB11), the controller 31 sends an application with a pre-determined format to the user terminal 41 (step SB12).

In the user terminal 41, when the application is sent, the user A fills in this application as user information, for example, personal information such as a name, a nationality, sex, an address, a telephone number, a date of birth of the user A and so forth.

In the management server 31, when the written application is received (step SB13), the controller 31 assigns the user ID to the received user information (step SB14), stores the user information and the corresponding user ID in the memory 312 (step SB15), and transmits and informs a registered notification together with the user ID to the user terminal 41 via the network N (step SB16).

By this utilization register, the user A can enjoy, for example, use of a mail function via the network N without a call charge, an application for the offer of a prize in a TV by one click operation, a purchase of products, a request of documents, a reservation and so forth.

If the register is not made as a member, services are not offered, for example, such as a home delivery service, an online payment and so forth since the user information is not clear.

Next, each of the process procedures following reception of broadcasting with the user terminal will be described in details.

When, for example, the user terminal 41 for the user A receives information relating to the advertisement that was broadcast with the satellite (step SC11), in this case, for example, a reception display image 51 of the TV advertisement is displayed on the display screen of the indicator 451 as shown in FIG. 14 (step SC12), and a musical composition of a music CD is output from a voice output section 461. Herein, on the reception display image 51, a selection button 51a is displayed for selecting and storing the corresponding “information icon”. Also, for example, in a dynamic image display area 511, the state is displayed in which this musical composition of the music CD is being performed.

In case that the user A who sighted and heard was interested in this TV advertisement, upon operating the selection button 51a on the display image (step SC13), the “information icon” that corresponds to this TV advertisement is registered on the “my page” stored in the memory 421 of the user terminal 41 (step SC14), and furthermore, the information icon ID that corresponds to the “information icon” is transmitted to the information management center 3.

Herein, the operation of the selection button 51a is carried out, for example, by pushing down a pre-determined key of the remote control terminal 471a1 (for example, a decision key) or by operating the pinpoint device 4721 (for example, clicking a mouse button).

In addition, in case that a pre-determined time elapsed without operating the selection button 51a (step SC15), this process finishes.

Later, when the user A activates the “my page” responding to his/her taste or responding to necessity (step SD11), the controller 411 transmits the user ID of the user A to the management server 31 of the information management center 3 (step SD12).

When the management server 31 receives the user ID (step SF11), it transfers to the delivery information storage server 32 this user ID and the information icon ID that is to be received successively (step SF12).

Between the user terminal 41 and the delivery information storage server 32, the information icon IDs stored in respective memories 421 and 322 are transmitted and received via the management server 31, and the information icons are synchronized (steps SD13, SH11 and SH12).

Also, the management server 31 correspondingly processes the user ID, information icon ID and so forth for database, which were transmitted and received here, and stores and manages them in the memory 312.

Furthermore, the management server 31 calculates a utilization fee responding to a handling volume of transaction to execute the charge process to the advertising sponsor (step SF13).

Next, the user terminal 41 downloads the “my page” for the user A within the memory 322 of the delivery information storage server 32 and, as shown in FIG. 15, causes the indicator 451 to display my page display image 52 (step SD14). In this my page display image 52 are displayed icon buttons 52a, 52b, . . . that corresponded to a pre-determined “information icon”. Herein, for example, the icon button that corresponds to a newly-added “information icon” is adapted so as to be easily distinguished by inverse display and so forth. Also, a synopsis is displayed by operating a synopsis button 52s.

After the user A knew the synopsis by viewing this my page display image 52, he/she selects the desired “information icon” by operating the corresponding icon button 52a (52b, 52c, . . . ) (step SD15).

Thereby, the controller 411 transmits to the management server 31 the user ID of the user A and the information icon ID that corresponds to the selected “information icon” (step SD16).

When the management server 31 receives the user ID and the information icon ID (step SF14), it transfers to the delivery information storage server 32 the user ID, the information icon ID and the corresponding user information (step SF15), and correspondingly processes the user ID, the information icon ID and so forth for database, which were transmitted and received here, stores and manages them in the memory 312.

Furthermore, the utilization fee is calculated responding to a handling volume of transaction to execute, for example, the charge process to the advertising sponsor (step SF16).

When the delivery information storage server 32 receives the user ID, the information icon ID and the user information from the management server 31 (step SH13), customizes detailed information relating to the pre-stored advertisement, based on the user ID, the user information and the information icon ID, prepares the “detailed my page” (step SH14) and transmits it to the user terminal 4 (step SH15).

For example, in case that this information icon ID corresponds to the advertisement, that information that “the user A is a female student” is included in the user information, and yet that “female students” are one part of target customers for the object product or service of the corresponding advertisement, in particular, for this user A, a customization is made so as to effectively affect the target customers whom the advertising sponsor hopes to sell in such a manner as “a gift of an overseas travel by lottery”, “a 50% off-discount of a selling price only for you” and the like.

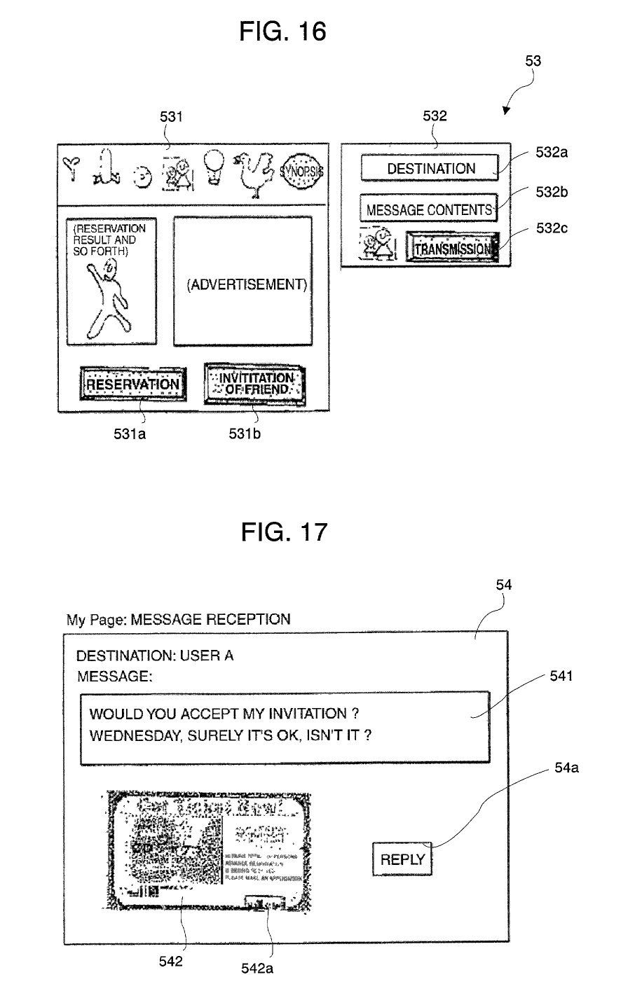

Next, in the user terminal 41, the controller 411 downloads the “detailed my page” from the delivery information storage server 32 (step SD17) to display the detailed my page display image 53 on the indicator 451 as shown in FIG. 16 (step SD18).

The detailed my page display image 53 includes a detailed information display image 531 and a display image for mail transmission 532, in the detailed information display screen 531 are provided a reservation button 531a and a recommendation button 531b, and in the display screen for mail transmission 532 are provided a mention area of a mail transmission destination 532a, a mention area of a transmission message 532b, and a transmission button 532c for initiating transmission.

Herein, if the user A who viewed the detailed information display image 531 would like to invite the user B who is one of his/her chums, by operating the recommendation button 531b (step SD19) to activate a program for the electronic mail, to input the destination of the user B and a message into the mention area of the mail transmission destination 532a and the mention area of the transmission message 532b respectively, and to operate the transmission button 532c, he/she transmits to the management server 31 the user ID of the user A, the destination of the user B, the message, the information icon ID and the information icon (step SD20).

When the management server 31 receives the mail with the information icon attached (step SF17), it transfers to the delivery information storage server 32 the user ID of the user A, the destination of the user B, the message, the information icon ID and the information icon (step SF18).

Also, the management server 31 correspondingly processes the user ID and the information icon ID received here, the user ID of the user B who is a recipient, and so forth for database, stores and manages them in the memory 312.

And, a contribution degree by the user A is evaluated on the fact that the reception contents were conveyed to the user B to add an evaluation score responding to a contribution degree. A reward (a discount service, a privilege service, and so forth) is given to the user A responding to a total of evaluation scores at this time (step SF19). In addition, in this example, as with the kind of the reward, the user A makes a choice.

Furthermore, the management server 31 calculates the utilization fee responding to a handling volume of transaction to execute, for example, the charge process to the advertising sponsor (step SF20).

When the delivery information storage server 32 receives the user ID of the user A, the destination of the user B, the message, the information icon ID and the information icon from the management server 31 (step SH16), it registers the message, the information icon and so forth on the “my page” for the user B (step SH17).

Later, when the user B activates the “my page” responding to his/her taste or responding to necessity (step SE11), the controller 412 transmits the user ID of the user A to the management server 31 of the information management center 3 (step SE12).

When the management server 31 receives the user ID (step SG11), it transfers to the delivery information storage server 32 this user ID and the information icon ID that is to be received successively (step SG12).

Between the user terminal 42 and the delivery information storage server 32, the information icon IDs stored respective in the memories 422 and 322 are transmitted and received via the management server 31, and the information icons are synchronized (steps SE13).

Also, the management server 31 correspondingly processes the user ID and the information icon ID for database, which were transmitted and received here, stored and manages them in the memory 312.

Furthermore, the management server 31 calculates the utilization fee responding to a handling volume of transaction to execute, for example, the charge process to the advertising sponsor (step SG13).

Next, the user terminal 42 downloads the “my page” for user B within the memory 322 of the delivery information storage server 32 and causes the indicator 452 to display my page display image 54 as shown in FIG. 17 (step SE14). In this my page display image 54 are provided a message display area 541, an information icon display area 542 that displays contents of the received “information icon”, and a reply button 54a.

After the user B knew the synopsis by viewing this my page display image 54, he/she operates the icon button 542a (step SE15).

Thereby, the controller 412 transmits to the management server 31 the user ID of the user B, and the information icon ID that corresponds to the “information icon” (step SE16).

When the management server 31 receives the user ID and the information icon ID (step SG14), it transfers to the delivery information storage server 32 the user ID, the information icon ID and the corresponding user information (step SG15), correspondingly processes the user ID, the information icon ID and so forth for database, which were transmitted and received here, stores and manages them in the memory 312.

And, a contribution degree by the user A is evaluated on the fact that the user B perused the electronic mail transmitted from the user A to add an evaluation score responding to a contribution degree (step SG16). Furthermore, the utilization fee is calculated responding to a handling volume of transaction to execute, for example, the charge process to the advertising sponsor (step SG17).

When the delivery information storage server 32 receives the user ID, the information icon ID and the user information from the management server 31, it customizes detailed information relating to the pre-stored advertising, based on the user ID, the user information and the information icon ID, prepares the “detailed my page”, and transmits it to the user terminal 42.

Next, in the user terminal 42, the controller 412 downloads the “detailed my page” from the delivery information storage server 32 (step SE17) and displays the detailed my page display image on the indicator 452 as shown in FIG. 16 (step SE18).

In case that the user B would like to reserve for buying, for example, the advertised product or service, he/she operates the reservation button 531a (step SE19). Thereby, the controller 412 transmits to the management server 31 the corresponding information icon ID and the user ID (step SE20).

When the management server 31 receives the information icon ID and the user ID (step SG18), it executes a reservation process of the product or service (step SG19).

And, based on the contents of the electronic mail transmitted from the user A and the detailed information, a contribution degree by the user A is evaluated on the fact that the user B reserved for buying the product or the service to add an evaluation score responding to a contribution degree (step SG20).

Furthermore, the management server 31 executes the data collection and analysis process, based on the result transmitted and received between each of the user terminals 41 (42, 43, . . . ) and the information management center 3 (step SG21).

Namely, to the pre-determined advertisement are searched a total number of perusals, a total number of perusals of the detailed information, a total number of transmission of the electronic mails, a total number of reservations of products or services and so forth and, furthermore, the analysis process thereof is executed to offer its analysis to the advertising sponsor and so forth, for example, as an effect measurement result, and the charge process is executed for this information providing service (step SG22).

In such a manner, in accordance with the arrangement of this example, since the detailed information, which was customized for each user based on the user information with regard to the advertisement that each user terminal received, is transmitted to each user responding to a request by each user, a sales promotion effect of products or services that are advertising objects can be enhanced.

Also, for example, in case that the reception contents were transferred as “private information”from the user A to the user B, since, based on the fact that the user A transferred the received contents to the user B, on the fact that the user B perused the electronic mail transmitted from the user A, and on the contents of the electronic mail and the detailed information transmitted from the user A, a contribution degree by the user is respectively evaluated on the fact that the user B reserved for buying the product or the service to add an evaluation score responding to a contribution degree, and a reward (incentive) is given to the user A responding to a total evaluation scores, a desire for actively transferring the reception contents to an acquaintance for invitation can be increased, a sales promotion effect of the products or the services that are advertising objects can be significantly enhanced, and a contribution to increase in sales volume of the products or services can be made.

And yet, since information exchange between fellow users is spurred actively with the transfer of this information and the invitation a turning point, it can be expected to spur prevalence of information of other advertisements.

Also, based on the result transmitted and received between each of the user terminals 41 (42, 43, . . . ) and the information management center 3, are searched a total number of perusals, a total number of perusals of the detailed information, a total number of transmission of the electronic mails, a total number of reservations for buying products or services and so forth to a pre-determined advertising, and furthermore the analysis process for them is executed, which can be offered to the advertising sponsor and so forth, for example, as an effect measurement result, and, for example, can contribute to effective management of the advertising sponsor.

### A SECOND EXAMPLE

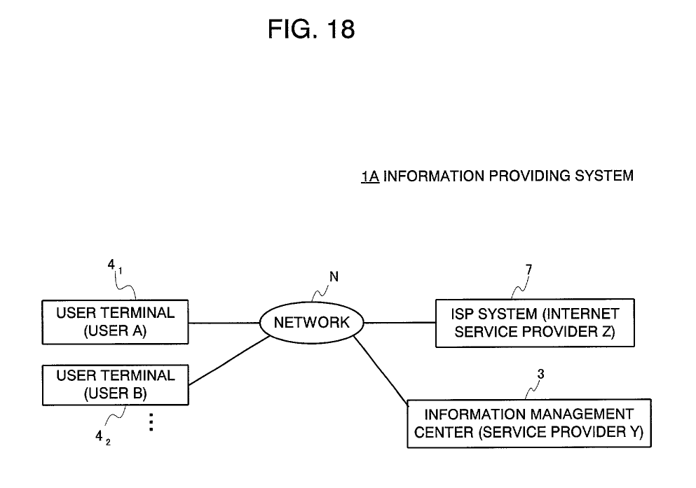

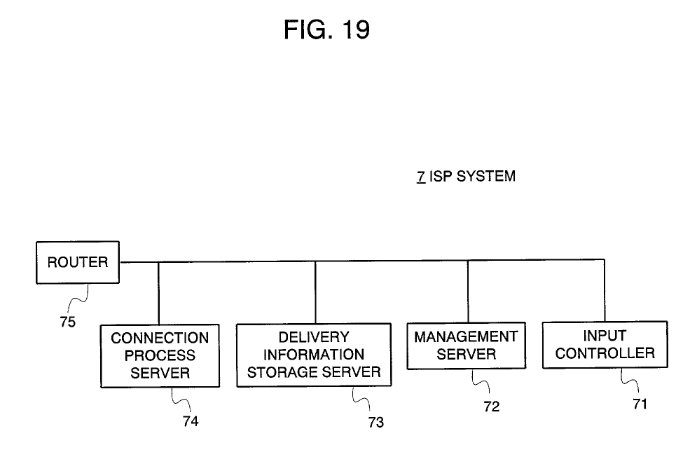

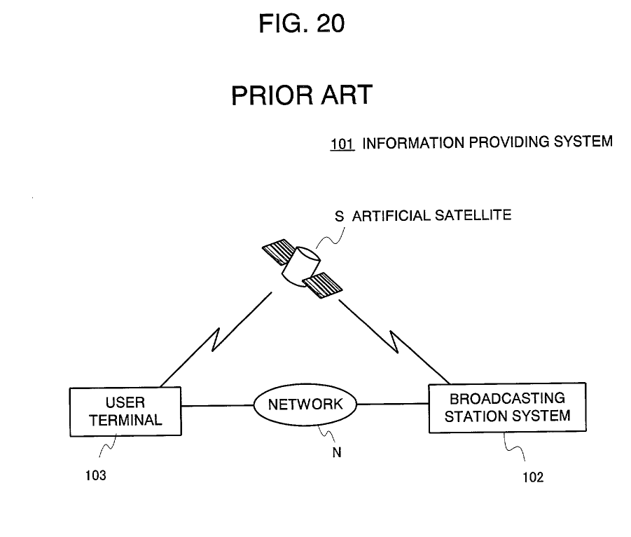

FIG. 18 is a diagram illustrating an arrangement of an information providing system that is a second example of the present invention, and FIG. 19 is a block diagram illustrating an arrangement of an ISP system in the same information providing system.

What the difference is between this example and the first example set forth above is that the first example set forth above is arranged so that a broadcasting enterpriser X broadcasts and delivers the advertisement with the satellite, and on the other hand, as shown in FIG. 18, this example is arranged so that an internet service provider Z broadcasts and delivers the above-mentioned advertisement with the network.

Since the other components of the arrangement of this example are almost the same as that of the first example except this, the explanation thereof will be omitted.

An information providing system 1A of this example comprises an ISP system (first information providing means) 7 that, as shown in FIG. 18, broadcasts the produced advertisement, which an internet service provider (ISP) Z manages, via the network N that belongs to the internet, and simultaneously transmits detailed information relating to the above-mentioned advertisement via the network N, the information management center 3 that receives the detailed information relating to the advertisement from the ISP system 7 via the network N to register it, and a number of the user terminals 41, 42 . . . that receive the advertisement, which is broadcasted with the internet, via the network N and simultaneously receive the detailed information relating to the above-mentioned advertisement from the information management center 3 via the network N.

As shown in FIG. 19, the ISP system 7 includes an input controller 71 that controls input of two kinds of contents, i.e. one for internet broadcasting and the other for network delivering, which is delivered to a pre-determined fellow via the network N, relating to the advertisement, a management server 72 that manages the entirety of the ISP system 7 and also manages, for example, information relating to the advertising sponsor, the advertising agent and so forth; a delivery information storage server 73, which stores information relating to the advertisement that was input, transmits information for internet broadcasting according to a broadcasting schedule, and transmits information for internet broadcasting to the information management center 3 responding to necessity, a connection process server 74 that connects each user terminal 41 (42, 43 . . . ) to the internet; and a router 25.

In the internet service provider Z, are received from the advertising agent, for example, two kinds of advertising with regard to an identical advertisement object that are for the internet broadcasting and for network delivering set forth above, which are different in detailing and the like, and information of these advertisements is input as image data, voice data, text data and so forth via the input controller 71.

Herein, information relating to the advertisement for network delivering set forth above includes, for example, detailed contents relating to the advertisement for internet broadcasting, and simultaneously is prepared in a form that can be customized individually for each user later.

Since, an information providing method using this information providing system 1A is almost the same as that of the first example, an explanation thereof will be omitted.

In accordance with the arrangement of this example, almost the same effect as what was described in the first example can be obtained.

Additionally, the information providing system can be arranged at a relatively low cost.

Above, the examples of the present invention have been described in details in reference to the drawings, specific arrangements are not limited to theses examples, the present invention may be varied in many ways without departing from its spirit and scope, and all such modifications are to be included in the present invention.

For example, in the example set forth above, the advertisement produced in the advertising agent is exemplified and explained as information that the broadcasting station broadcasts, but the information is not limited hereto, of course the case is the same in which the program produced within the broadcasting station is broadcast.

In this case, in the broadcasting station, the program for satellite broadcasting and detailed information of the above-mentioned program for network delivering with small details, which is delivered via the network N, are produced by use of the “information icon” and are input into the broadcasting system 2 respectively, the program for satellite broadcasting is transmitted from the transmission station apparatus 24 and the detailed information of the program is transmitted to the information management center 3.

Also, in this case, when the management server 31 executes the charge process, an object of the charge is the broadcasting enterpriser X. Also, in the collection and analysis process of the utilization status of this system, for example, information relating to an audience rating of the program is obtained, and in the evaluation process of a contribution degree by a user, for example, an evaluation for the user is made responding to a degree to which he/she contributes to an improvement in the audience rating.

Also, the case was described in which the “my page” was pre-installed in the user terminal 41, 42, . . . , but it can be adapted to be delivered from the information management center 3 at the time of the utilization register by the user.

Also, for example, a charge process function may be separated from the management server 31 of the information management center 3 to provide a charge server independently, and a plurality of the delivery information storage servers 32 may be distributed and positioned.

Also, in case that the user A has not sufficient time, even though he/she would like to invite a friend, for example, the user B for a concert and so forth, an arrangement may be made so as to make a request to the information management center 3 to the effect that the prompt report with the same contents is required to be simultaneously transmitted to the other terminals for the user B such as, for example, a PDA, a facsimile and so forth via, for example, the network N, when the electronic mail, which was addressed to the user terminal 42 for the user B, is transmitted via the information management center 3.

In addition, transmission of this prompt report may be made via the other communication channel than the network N. Also, in case of transmitting the prompt report, the electronic mail may be adapted to be omitted. Also, after transmitting the electronic mail, when no reply arrived from the user terminal 42 even though a pre-determined time has elapsed, the prompt report may be transmitted from the information management center 3. Also, in the user terminal 42, in case that the electronic mail with a high emergency was received, an arrangement can be made in which means for informing of that effect is provided.

Also, the information management center 3 may be installed within the broadcasting station.

Also, one part of the user terminal 41, 42, . . . may be arranged so as to omit the reception process 431, 432, . . . to receive information only via the network N.

Also, the case was described in which the recommendation information was conveyed from the user A to the user B, but the user A may convey the recommendation information to a plurality of the users at the same time.

Also, the network N may include not only a wire but also a wireless. Also, the user terminal 41, 42, . . . may be arranged so as to comprise, for example, a note-type personal computer and the like, and a mobile telephone, and may employ a mobile telephone having a data communication function.

Also, the program or the advertisement may be broadcast with, for example, a ground wave broadcast, a CATV and so forth in addition to the satellite data broadcast.

As explained above, in accordance with the present invention, with regard to the first information including the program or the advertisement, which the information receiving terminal for a pre-determined customer received, since the detailed information customized for the customer based on the customer information of the above-mentioned customer is transmitted to the information receiving terminal, for example, an advertising effect of the program, and a sales promotion effect of products or services that are advertising objects can be enhanced.

Also, in case that the reception contents were recommended by a first customer to a second customer user, by rewarding the first customer responding to a contribution degree to prevalence of at least the first information by the first customer, a desire for actively transferring the received contents to an acquaintance for invitation can be increased, and for example, a contribution can be made to improvement in an audience rating of the program and to increase in sales volume of products or services.

Also, by executing the analysis process for the communication information at the moment when at least the first information is prevailed by the first or the second customers, since this analysis result can be offered as, for example, an audience situation report of the program or an effect measurement result report of the advertisement to the broadcasting station, the advertising agent and so forth, a contribution can be made to preparation of information which is effective in management of the broadcasting station and the advertising sponsor.

The entire disclosure of Japanese Patent No. 2000-205779 filed on Jul. 6, 2000 including specification, claims, drawing and summary are incorporated herein by reference in its entirety.

What is claimed is:

1. An information providing system, comprising:
information providing means of delivering at least anyone of first information including a pre-determined program or advertisement and second information including additional information relating to said first information; and
an information receiving terminal for a customer that receives at least anyone of said first information and said second information,
wherein in case of transmitting said second information to said information receiving terminal, said information providing means transmit said second information addressed to said information receiving terminal, which was prepared for said customer corresponding to customer information relating to said customer, and
wherein simultaneously an information transfer path, which is used in case that said first information is transmitted and received between said information providing means and said information receiving terminal, and an information transfer path, which is used in case that said second information is transmitted and received between said information providing means and said information receiving terminal, are identical or different.

2. An information providing system, comprising:
first information providing means that deliver via a first information transfer path first information including a pre-determined program and advertisement;
second information providing means that deliver via a second information transfer path second information including detailed information relating to said first information; and
an information receiving terminal for a customer that receives said first information via said first information transfer path and that receives said second information via said second information transfer path,
wherein said second information providing means transmit said second information addressed to said information receiving terminal, which was prepared for said customer corresponding to customer information relating to said customer.

3. An information providing system, comprising:
first information providing means that deliver via a first information transfer path first information including a pre-determined program and advertisement;
second information providing means that deliver via a second information transfer path second information including detailed information relating to said first information;
a first information receiving terminal for a first customer that receives said first information via said first information transfer path and that receives said second information via said second information transfer path responding to necessity; and
a second information receiving terminal for a second customer that receives at least said second information responding to necessity,
wherein said first information receiving terminal transmits to said second information receiving terminal for said second customer via said second information providing means recommendation information for at least one said second customer, which was prepared based on either said first or said second information, and
wherein said second information providing means transmit to said information receiving terminal said second information for said first customer, which was prepared corresponding to first customer information relating to said first customer, responding to a request from said first information receiving terminal, and in case that it received said recommendation information from said first information receiving terminal, it simultaneously transfers said recommendation information to said second information receiving terminal, and yet transmits to said second information receiving terminal said second information for said second customer, which was prepared corresponding to said recommendation information and second customer information relating to said second customer, responding to a request from said second information receiving terminal.

4. The information providing system according to claim 3, wherein said first information receiving terminal prepares recommendation information for a single or plural specific said second customer(s) based on said first or said second information responding to necessity to transmit said recommendation information to said second information receiving terminal via said second information providing means.

5. The information providing system according to claim 3, comprising evaluation means of making an evaluation for rewarding said first customer responding to a contribution degree by said first customer to prevalence of at least said first information.

6. The information providing system according to claim 5, wherein, in case that said first information includes advertising information, said evaluation means make an evaluation for rewarding said first customer responding to a contribution degree to commercial transaction achievements relating to products or services as an object of an advertisement.

7. The information providing system according to claim 3, comprising:
information management means of managing communication information indicating that at least said first information was prevailed by said first or said second customer; and
information analysis means of executing a collection and analysis process for said communication information to obtain an analysis result on a prevalence situation of said first information, which is to be offered to a provider of said first information.

8. The information providing system according to claim 7,
wherein said information analysis means execute a collection and analysis process for said communication information based on customer information of said first and said second customers who transmit and receive at least said first information.

9. The information providing system according to claim 3, comprising a third information receiving terminal for said second customer that receives at least prompt report information that corresponds to said recommendation information,
wherein said second information providing means transmit said prompt report information to said third information receiving terminal responding to a request by said first information receiving terminal.

10. The information providing system according to claim 3, wherein said second information providing means transmit to said second information receiving terminal at least prompt report information, which corresponds to said recommendation information, responding to a request by said first information receiving terminal.

11. The information providing system according to claim 10, wherein, after said second information providing means transmitted to said second information receiving terminal said recommendation information received from said first information receiving terminal, it transmits said prompt report information to said third information receiving terminal in case that no reply from said second information receiving terminal is present within a pre-determined time.

12. The information providing system according to claim 3, wherein said customer information includes at least anyone of a name, a race, a nationality, sex, an address, an age, and an occupation.

13. An information providing method, comprising:
an information providing step of delivering at least anyone of first information including a pre-determined program or advertisement and second information including additional information relating to said first information; and
an information receiving step of receiving at least anyone of said first information and said second information with an information receiving terminal for a customer,
wherein, in said information providing step, in case of transmitting said second information to said information receiving terminal with said information providing means, said second information addressed to said information receiving terminal, which was prepared for said customer corresponding to customer information relating to said customer, is transmitted, and
wherein simultaneously an information transfer path, which is used in case that said first information is transmitted and received between said information providing means and said information receiving terminal, and an information transfer path, which is used in case that said second information is transmitted and received between said information providing means and said information receiving terminal, are identical or different.

14. An information providing method, comprising:
a first information providing step of delivering first information including a pre-determined program or advertisement via a first information transfer path with first information providing means;
a second information providing step of delivering second information including detailed information relating to said first information via a second information transfer path with second information providing means; and
an information receiving step of receiving said first information via said first transfer path and of receiving said second information via said second information transfer path with an information receiving terminal for a customer, and
wherein, in said second information providing step, with said information providing means, second information addressed to said information receiving terminal, which was prepared for said customer corresponding to customer information relating to said customer, is transmitted.

15. An information providing method, comprising;
a first information providing step of delivering first information including a pre-determined program or advertisement via a first information transfer path with first information providing means;
a second information providing step of delivering second information including detailed information relating to said first information via a second information transfer path with second information providing means;
a first information receiving step of receiving said first information via said first transfer path and of receiving said second information via said second information transfer path responding to necessity with a first information receiving terminal for a customer; and a second information receiving step for a second customer of receiving at least said second information responding to necessity via said second information transfer path with a second information receiving terminal for a second customer,
wherein, with said first information receiving terminal, recommendation information for at least one said second customer, which was prepared based on said first or said second information, is transmitted to said second information receiving terminal for said second customer via said second information providing means responding to necessity, and
wherein said second information providing means transmit to said first information receiving terminal said second information for said first customer, which was prepared corresponding to first customer information relating to said first customer, responding to a request from said first information receiving terminal, simultaneously, in case that it received said recommendation information from said first information receiving terminal, it transmits said recommendation information to said second information receiving terminal, and yet transmits to said second information receiving terminal said second information for said second customer, which was prepared corresponding to said recommendation information and second customer information relating to said second customer, responding to a request from said second information receiving terminal.

16. The information providing method according to claim 15, comprising an evaluation step of making an evaluation for rewarding said first customer responding to a contribution degree by said first customer to prevalence of at least said first information.

17. The information providing method according to claim 16, wherein, in case that said first information includes advertising information, an evaluation is made for rewarding said first customer responding to a contribution degree to commercial transaction achievements relating to products or services as an object of an advertisement.

18. The information providing method according to claim 15, comprising:
information management means of managing communication information indicating that at least said first
information was prevailed by said first or said second customer; and
information analysis means of executing a collection and analysis process for said communication information to obtain an analysis result on a prevalence situation of said first information, which is to be offered to a provider of said first information.

19. The information providing method according to claim 15, comprising:
a prompt report information transmission step of transmitting to a third information receiving terminal for said second customer at least prompt report information, which corresponds to said recommendation information, responding to a request by said first information receiving terminal with said second information providing means; and
a prompt report information receiving step of receiving said prompt report information with said third information receiving terminal,
wherein, in said prompt report information transmission step, with said third information means, after said recommendation information received from said first information receiving terminal was transmitted to said second information receiving terminal, said prompt report information is transmitted to said third information receiving terminal in case that no reply from said second information receiving terminal is present within a pre-determined time.

20. A record medium in which an information providing program was recorded, wherein a program is recorded for causing a computer to execute:
an information providing step of delivering at least anyone of first information including a pre-determined program or advertisement and second information including additional information relating to said first information with information providing means; and
an information receiving step of receiving at least anyone of said first information and said second information with an information receiving terminal for a customer,
wherein, in said information providing step, in case of transmitting said second information to said information receiving terminal with said information providing means, said second information addressed to said information receiving terminal, which was prepared for said customer corresponding to customer information relating to said customer, is transmitted, and
wherein simultaneously an information transfer path, which is used in case that said first information is transmitted and received between said information providing means and said information receiving terminal, and an information transfer path, which is used in case that said second information is transmitted and received between said information providing means and said information receiving terminal, are identical or different.

21. A record medium in which an information providing program was recorded, wherein a program is recorded for causing a computer to execute:
a first information providing step of delivering first information including a pre-determined program or advertisement via a first information transfer path with first information providing means;
a second information providing step of delivering second information including detailed information relating to said first information via a second information transfer path with second information providing means; and
an information receiving step of receiving said first information via said first information transfer path and of receiving said second information via said second information transfer path with an information receiving terminal for a customer,
wherein, in said second information providing step, with said second information providing means, second information addressed to said second information receiving terminal, which was prepared for said customer corresponding to customer information relating to said customer, is transmitted.

22. A record medium in which an information providing program was recorded, wherein a program is recorded for causing a computer to execute:
a first information providing step of delivering first information including a pre-determined program or advertisement via a first information transfer path with first information providing means;
a second information providing step of delivering second information including detailed information relating to said first information via a second information transfer path with second information providing means;
a first information receiving step of receiving said first information via said first information transfer path and of receiving said second information via said second information transfer path responding to necessity with a first information receiving terminal for a first customer; and
a second information receiving step for a second customer of receiving at least said second information via said second information transfer path responding to necessity with a second information receiving terminal for a second customer,
wherein recommendation information for at least one said second customer, which was prepared based on said first or said second information, is transmitted to said second information receiving terminal for said second customer via said second information providing means responding to necessity with said first information receiving terminal, and
wherein said second information providing means transmit to said first information receiving terminal said second information for said first customer, which was prepared corresponding to first customer information relating to said first customer, responding to a request from said first information receiving terminal, simultaneously, in case that it received said recommendation information from said first information receiving terminal, it transfers said recommendation information to said second information receiving terminal, and yet transmits to said second information receiving terminal said second information for said second customer, which was prepared corresponding to said recommendation information and second customer information relating to said second customer, responding to a request from said second information receiving terminal.

23. The record medium having recorded the information providing program according to claim 22, wherein a program was recorded for causing a computer to execute an evaluation step of making an evaluation for rewarding said first customer responding to a contribution degree by said first customer to prevalence of at least said first information.

24. The record medium having recorded the information providing program according to claim 23, wherein, in said evaluation step, in case that said first information includes advertising information, an evaluation is made for rewarding said customer responding to a contribution degree to commercial transaction achievements relating to products or services as an object of an advertisement.

25. The record medium having recorded the information providing program according to claim 22, wherein a program is recorded for causing a computer to execute:
a prompt report information transmission step of transmitting at least prompt report information, which corresponds to said recommendation information to a third information receiving terminal for said second customer, responding to a request by said first information receiving terminal with said second information providing means; and
a prompt report information receiving step of receiving said prompt report information with said third information receiving terminal, and
wherein, in said prompt report information transmission step, with said second information providing means, after said recommendation information received from said first information receiving terminal was transmitted to said second information receiving terminal, said prompt report information is transmitted to said third information receiving terminal in case that no reply from said second information receiving terminal is present within a pre-determined time.
